(19) United States
(12) Patent Application Publication
(10) Pub. No.: US 2016/0193539 A1
(43) Pub. Date: Jul. 7, 2016

(54) VISUAL, AUDIO, LIGHTING AND/OR VENUE CONTROL SYSTEM

(71) Applicant: Kody Hornburg, Aspen, CO (US)

(72) Inventor: Kody Hornburg, Aspen, CO (US)

(21) Appl. No.: 14/957,461

(22) Filed: Dec. 2, 2015

Related U.S. Application Data
(60) Provisional application No. 62/086,578, filed on Dec. 2, 2014.

(51) Int. Cl. A63J 99/00; H05B 37/02; G06F 3/16; G06F 3/01; G05B 15/02

(52) U.S. Cl. CPC A63J 99/00; G06F 3/014; G05B 15/02; G06F 3/165; H05B 37/0272

(57) ABSTRACT

A system and method adapted to allow a user, such as a performer, audio engineer and/or lighting designer, to have mobile and/or directional control of performance elements. The user may use specialized control devices, such as performance gloves, in order to control performance and/or technical features, such as a surround sound system, visual, audio, lighting and venue control system or other software, as well as lighting and visual control surfaces during a studio, recording or live performance to give an audience a unique multi-sensory experience.

### CROSS-REFERENCE TO RELATED APPLICATIONS

This application claims the benefit of U.S. provisional application No. 62/086,578, filed Dec. 2, 2014, which is hereby incorporated by reference as though fully set forth herein.

### BACKGROUND

a. Field

The instant invention relates to electronic systems useful in controlling parameters and effects of performances.

b. Background

A disk jockey (DJ), FOH (Front of House Engineer), and a LD (Lighting Designer) are typically stationary behind a table, sound or light board with computers and other mechanisms for creating and/or controlling music being played to the audience. This limits the performance possibilities of a performer and does not fully utilize a stage.

### BRIEF SUMMARY

Electronic systems adapted to manipulate music, songs, sounds, instruments, effects, and visuals in a studio, recording or live environment performance are provided. In one implementation, for example, the electronic systems are adapted to manipulate music, songs, sounds, instruments, effects and/or visuals as a performing disk jockey in a studio, recording or live setting. The electronic systems may also be adapted to control sound boards for audio engineers and lighting boards for lighting designers. The electronic systems may be used by various users to provide personalized control of one or more aspects of the studio, recording or live performance.

In one implementation, an electronic system frees a performer to move about a stage while remotely controlling equipment about the stage or otherwise within a venue. Similarly, the control system is adapted to allow a sound engineer to walk around the venue and adjust the sound based on conditions existing or detected in different areas of the venue. The electronic systems may also enable the sound engineer to walk freely around the venue while wearing a controller (e.g., one or more glove controllers) to control and adjust the audio as needed, without having to run back and forth from the sound booth. The electronic systems may also be adapted to enable a lighting designer to control stage lights and visuals directly in their hands. Thus, using the electronic systems, the lighting designers may move freely away from the lighting control board painting the stage setting with the remote controllers (e.g., gloves).

Thus, in various implementations, systems and methods are provided that enable a user, such as a performer, sound engineer and/or lighting designer, to have mobile and/or directional control of programmable technical and performance elements within a performance setting or venue. The systems and methods are adapted to allow the user (e.g., performer/engineer/designer) to use specialized control devices in order to control technical or performance features during a performance. In some implementations, control devices include wearable controllers (e.g., performance gloves), floor pads, motion tracking sensors, and/or remote controls. In some implementations, performance features include surround sound, soundboards, lighting, software/hardware, temperature, fans, and/or scent. The use of control devices to direct a performance may be used to create a unique audience experience.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows an example implementation of a remote controller and control system implementing example control features in which the remote controller includes one or more performance glove remote controllers.

FIG. 2 shows additional example implementations of remote controller implementations that may be used within a control system in which individual example implementations of performance glove remote controllers include different control mechanisms and/or placements on the glove remote controller implementations.

FIG. 3 shows further example of speaker positioning and considerations when calibrating speakers for a particular venue.

FIG. 4 shows a front perspective view of a stage demonstrating an embodiment of the present disclosure using a control pad/mat.

FIG. 5 is a schematic diagram of an example computing device 1000 upon which the controller of the venue control system may be implemented.

FIG. 6 shows an example implementation of operations that may be used within a control system such as described and shown herein

### DETAILED DESCRIPTION

Systems and methods are provided that enable a user, such as a performer, sound engineer, and/or lighting designer, to have mobile and/or directional control of programmable technical and performance elements of the control system. In one implementation, for example, the systems and methods are adapted to allow the user to use specialized control devices in order to control performance features in a studio, recording or live performance. In some implementations, control devices include performance gloves, floor pads, motion tracking sensors, and/or remote controls. In some implementations, performance features comprise sound, lighting, software/hardware, temperature, fans, and/or scent. The systems and methods are designed to be flexible to a performer's preferences or based on a performance's requirements.

### Control Devices

In one implementation, a performance system comprises specially designed remote controller devices. In one particular example, the remote controller devices comprise one or more technical and performance gloves or other wearable controller. In this particular implementation, for example, a pair of gloves is adapted to be a source of channeling the user's (e.g., engineer, designer and/or performer's) movements and expression into a captivating visual and audio artistic masterpiece. The performance gloves, for example, may be adapted to bring a performer and engineer, such as a DJ, out from behind the turntables without sacrificing any amount of control while being much closer and interactive with the audience. While the sound engineer can move about the venue creating and maintaining an unbeatably accurate audio mix for the audience. A lighting designer can similarly stand wherever he or she chooses that gives the best view/angle of the stage and enabling the designer to paint and perform the lighting and visuals. The controls and sensors of the gloves or other remote controller may be used to maximize/optimize or otherwise improve a performer or engineer's ability to manipulate songs, sounds, effects, and frequencies by translating a performer or engineer's basic movements into bigger, more visually stimulating, actions. In this implementation, the controller may enables an audience to associate each movement with each sound in a more accurate manner where the controller and the control system are designed to link movements of the user that are related to modifications of one or more effects for a performance. A user, for example, may increase one or more settings (e.g., volume, frequency, lighting intensity, etc.) via a motion such as raising one or both of the user's arms further and further into the air. Similarly, a pointing or other directional movement may be adapted to provide a correlated directional effect of the performance, such as by pointing or motioning in a direction (e.g., a throwing motion) and controlling a setting of the performance (e.g., surround sound control, lighting control, etc.) correlated to the motion.

The gloves or other remote controller(s) are adapted to enable the user to channel movements and expression into an incredibly captivating visual and audio artistic masterpiece. The gloves enable a user (e.g., performer such as a DJ) to move out from behind the turntables without sacrificing control while being much closer and interactive with the audience. Similarly, the sound engineer can move about the venue creating and maintaining an accurate audio mix for the audience. Finally, the lighting designer can stand wherever he/she chooses that gives the designer the best view/angle of the stage and enabling them to paint and perform the lighting and visuals. The controls and sensors of the gloves enable a performer or engineer's ability to manipulate songs, sounds, effects, and frequencies by translating a performer or engineer's basic movements into bigger, more visually stimulating, actions. This allows the audience to associate each movement with each sound in a more accurate manner.

In one implementation, for example, the gloves may transmit data through wired or wireless communication, including the use of USB, radio frequencies, Bluetooth, infrared, Wi-Fi, or motion tracking sensors. A power source of the gloves may be incorporated into the gloves, be attached to the wearer of the gloves, or may be connected in some other way, such as USB.

Multiple types of control mechanisms may be incorporated into a remote controller that may be used to control one or more aspects of a performance. The remote controller, for example, may include any type of remote controller including, but not limited to one or more wearable controllers such as an example implementation using performance controller gloves. The remote controller, for example, may include control mechanisms such as, but not limited to, buttons, triggers, control bars, sliders, accelerometers, gyroscopes, motion sensors and other mechanisms. In some implementations, for example, wearable gloves may include control mechanisms at a location and sized such that the control mechanisms can be configured so that it could be controlled by the hand wearing the glove or a separate hand. Buttons and triggers, for example, are programmable for compatibility with any individual's preferences in some implementations. In some implementations, buttons are located on fingertips and activated by connecting the button with a mechanism on the thumb. Buttons may also be located at other points that may be easily reached, such as finger joints. In some implementations, pad bank buttons are used to maximize use and possibilities of all buttons or triggers without compromising comfort or space. Accelerometers on one or both hands may be configured to detect tilt, angular and translational motion, orientation, and speed to control performance features, including the manipulation of sounds, songs, software, hardware soundboards at studio, recording or live venues, or anything that is programmable with/through MIDI signals.

For further control, motion tracking sensors in the performance gloves may be coupled with motion tracking sensors on the stage and or proscenium to more accurately track a performer's position and actions. A performer may have various controls be location specific. For example, a performer moving to stage left and then throwing both hands in the air may cause fireworks to activate on stage left. In some implementations, specific sounds/effects are triggered when a glove enters into a drawn/programmed area of the stage. The same could be applied to a sound engineer or lighting designer, placing motion sensors around the user designated area such as a sound/light board or the entire sound booth giving the user complete control as well as the mobility to move about the venue in an environment that is normally where one is restricted to a specific area.

In one implementation, the performance system allows a performer or engineer to control performance and technical features in various ways. For example, a performer could visually move the gloves in the air to manipulate sounds, frequencies, lights, colors, and other effects towards specific areas of a crowd or through and around the entire crowd. While the sound engineer is walking around the venue controlling different knobs, and faders by moving one hand up or down to adjust volume or other parameters on the spot, and the lighting designer is moving his hands like a painter and performing the lights and visuals with every movement.

When enabled, a DJ could appear to grab and hold sounds and special effects out of the thin air, and then the DJ could throw them to different mapped and pre-programmed locations throughout the venue. In further implementations, multiple performers could pass the sounds/effects to each other in multiple regions of the performance area. Throwing sounds/effects around and through audience may be accomplished by configuring performance equipment, such as the surround sound system specifically designed as the main element to maximize the use and control of audio during the show. Proper timing and audio guidance devices can be used to ensure that the entire audience hears and feels the sounds as directed, whether that is every audience member hearing it at the same time or having different sections of the audience hearing the sound manipulated at different volumes, timing, frequency, and other variations. This will manipulate a user into feeling closer or further than they actually are, and experiencing music in a way that isn't found in any other studio, recording or live music venue.

The performance glove may further comprise display elements to contribute to the performance features. For example, the gloves may comprise LEDs, lasers, or other lighting effects that are used to capture the attention of the audience. These lighting effects may be programmed to react to the various control mechanisms, such as the pushing of buttons, movement of accelerometers, specific gestures, and other controls. Additionally, they may be synchronized with various performance features. For example, when in use with a temperature control, the lights could turn red for hot and blue for cold. When in use with a mist control, lasers may show in mist to visually demonstrate to the audience which speakers or equipment is being manipulated by the performer or to indicate to the audience that the glove is the main control mechanism.

In some implementations, the system comprises a control X/Y pad/mat designed to be controlled by a performer or engineer's feet. In some implementations, the control pad is laid flat on the stage or area in the sound booth with programmable coordinates that the user could draw in preferred shapes or areas for any given control or parameter. These control zones could be triggered by the user stepping in or on the area. The control zones could be programmable to control performance features, such as lighting and sound. They could also be used in conjunction with other control mechanics to assist in determining the location of a performer or engineer. In some implementations, pad bank buttons located on the gloves are be programmed to add more pad banks to the control pad/mat.

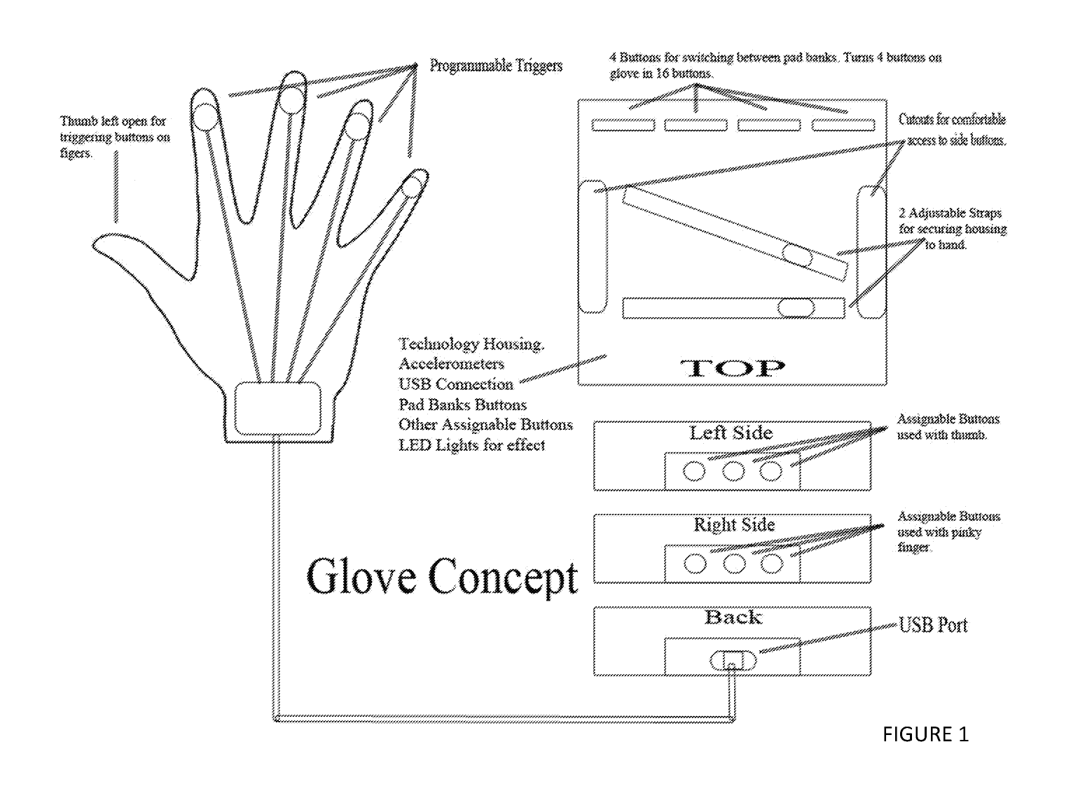

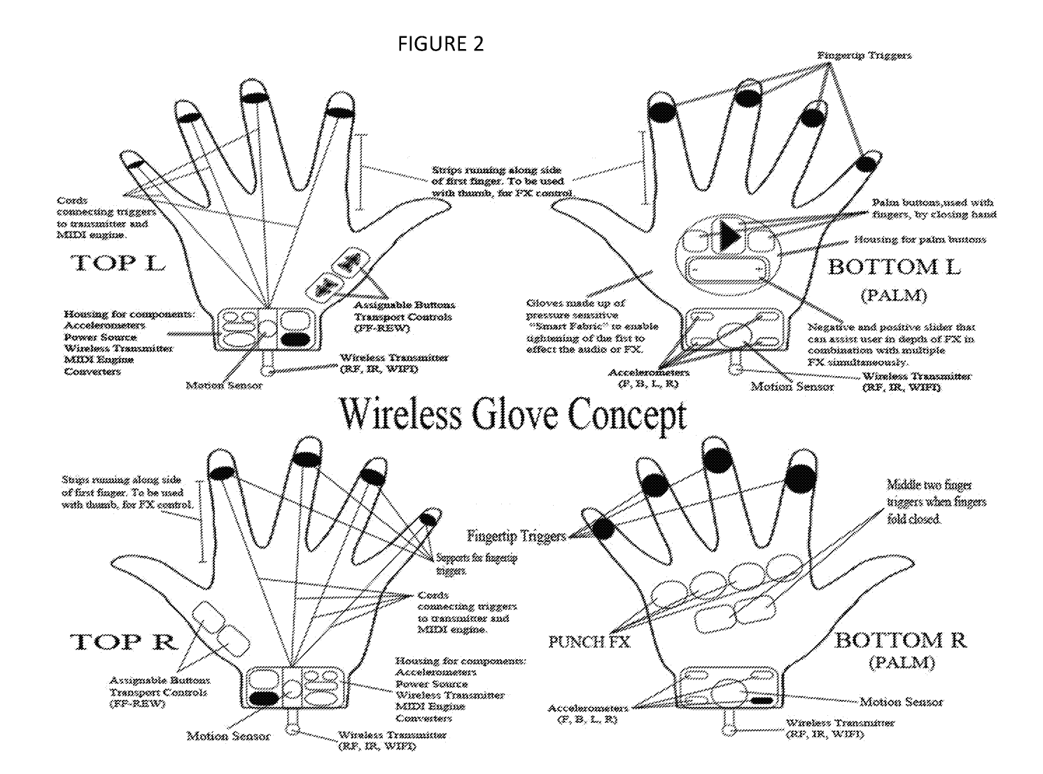

FIGS. 1 and 2, for example, depict example remote controller designs implemented as wearable remote controller devices. In the particular implementations shown in FIGS. 1 and 2, for example, the wearable remote controller designs comprise wearable performance glove controllers that may be worn on one or both hands of a user. Although FIG. 1 shows a first wired implementation and FIG. 2 shows wireless implementations, the particular designs are not so limited. Rather, any implementation discussed herein, may include a wired or wireless implementation. Further, the individual gloves may be wired to another discrete or attached wireless communication device (e.g., a wearable communication device) that may be worn by the user (e.g., on a belt). Further, the particular input/output devices shown or described with reference to particular controller implementations are merely examples and any number of input/output devices may be implemented within one or more remote controller (e.g., the wearable glove remote controllers shown and described herein).

FIG. 1, for example shows an example remote glove controller that is wired into a control system as shown and described herein. In this particular implementation, for example, the remote control performance glove is wired via a USB connector, although any type of wired or wireless communication device or method may be used. In this particular implementation, the glove remote controller includes a plurality of programmable triggers (e.g., buttons) disposed on one or more fingers of the glove. The thumb portion of the glove controller is left open for triggering the buttons disposed on the fingertips of the glove controller. Any number, type and design of input and/or output devices (e.g., a status indicator for one or more input device) may be used in any number of configurations.

Additional controllers that may be used to control/assign functions to the one or more input/output devices on the glove controller(s) are coupled to the glove controller(s). The additional controls may, for example, be disposed on another wearable remote controller (e.g., on the user's arm, waist or the like). Alternatively or additionally one or more of the additional controls may be disposed on a panel, board or other location, such as located at a DJ table sound board or the like, where the user may select one or more programmable functionalities before moving away from that location. Thus, the user may selectively assign one set of functions for a first portion of a performance, be able to use that set of functions for the first portion of the performance, return (or select on a remote device) to select a second set of functions for a second portion of the performance. Further, third, fourth and additional sets of functions may be selected by the user at any point in time during a performance. Alternatively, the various sets of functions may be programmed in advanced for different portions of a performance and may be overridden by the selectors shown in FIG. 1.

In the particular example implementation shown in FIG. 1, a plurality of input devices (four buttons in FIG. 1) may be disposed in a first location (e.g., a top location of a device) accessible by the user during a performance. The input devices may be selected for assigning one or more different sets of functions attributable to the programmable triggers disposed on the performance glove remote controller. The device may similarly include cutouts or other access to additional input/output devices, straps or other attachments for attaching the controller device to the user and/or to a location where it may reside during all or a portion of a performance. The device shown in FIG. 1 may additionally include one or more other sensors, input devices, output devices or the like. For example, the device may include one or more accelerometers, wired or wireless connection devices, buttons, wheels, slides, lights, displays or the like.

FIG. 2 shows a further example implementation of a pair of remote wearable performance glove controller design. In this particular implementation, for example, the glove controllers include a first left glove and a second right glove for wearing on a user's left and right hands, respectively. On the first left glove, for example, the glove includes a plurality of triggers disposed on or near the fingertips of the first left glove coupled to a control housing disposed on the back of the of the first left glove. The locations of components of the glove are merely exemplary. The triggers, in this particular implementation, are coupled to the control housing via one or more wired connections that are adapted to receive inputs from the triggers. Further, one or more assignable buttons that may be configured via software and/or hardware to provide different sets of functions are provided in this implementation on a back of the first left glove at a thumb location of the glove. On the bottom (or palm) of the first left glove additional fingertip trip triggers may be disposed for additional functionalities. Further strips, slides or other longitudinal or rotational input devices are disposed along the sides of the fingers of the gloves and adapted to provide one or more continuous input for receiving varying inputs that may be used for controlling variations of a performance attribute (e.g., volume, frequency, intensity or the like). The palm of the glove may also include additional input/output devices. Input devices on the palm of the hand may be activated or selected by a finger, thumb or by simply closing the user's hand (e.g., forming the hand into a fist). In the implementation of FIG. 2, a slider input device is also shown on the palm. In one particular example, the slider input device may be adapted to assist the user in depth of function in combination with other functions simultaneously. The gloves may further comprising pressure sensitive smart fabrics adapted to detect the user tightening the hand into a fist or ball to affect one or more performance attributes.

The second right hand of the performance glove remote controller, in this particular implementation, may further include other input and/or output devices as shown in FIGS. 1 and 2 adapted to receive one or more input from a user and/or provide one or more output to the user. As shown in FIG. 2, the glove remote controllers may further comprise a housing for components such as but not limited to accelerometers, power sources, wireless transmitters, wired communication ports, a MIDI engine, converters, motion sensors or the like.

### Technical/Performance Features

In various implementations, the performance features may comprise speakers to convey the sound to the audience. In some implementations, this would include a studio, recording or live surround sound system to enable sounds to be conveyed from multiple locations and/or angles. In order for a studio, recording or live surround sound system to maximize its effect on an audience, each speaker may be placed at locations determined to maximize the audience in a “sweet spot.” In some implementations, for example, speaker arrays are elevated in positions around an audience to create this sweet spot. Proper calibration may be utilized to take into account a specific venue. In some implementations, the speaker array placement and direction of the speakers is calculated at each venue to achieve a full surround sound effect exclusive to this performance system. In some implementations, this may involve the use of timing devices (pre-delays) to ensure the entire audience hears every sound at the exact same time without any audible timing issues. The speaker arrays may be mounted on towers or elevated in other ways. Such towers can be designed to be stable so that it can compensate for any wind, sway, or other factors that may affect its movement. In some implementations, the system further comprises deflectors or sound guides to direct sound to the audience while avoiding any frequency cancellation or misdirected sound waves. In one implementation, software for this system includes a real time audio analyzer that allows the sound engineer to accurately see and measure on a screen where each speaker/frequency is and needs to be directed and/or reflected.

In some implementations, the speakers would act as normal speakers projecting every aspect of every sound until surround sound panning is engaged by the user and single songs, sounds, and effects could be isolated by using the gloves and the mapped-out coordinates allowing the user to hold and throw sound and/or specific characteristics of any song, sound, or frequency to specific areas of the audience that the user chooses in real time.

In some implementations, the performance features comprise visual displays that are manipulated by the control devices. These visual displays include, but are not limited to, the use of 3D projections, virtual reality displays, multi-layered screens, 3D glasses, and laser/fog displays. For example, a visual display for a performance may include projections on 3 or 4 sides of the stage and audience (above the stage, stage left, stage right, rear) creating a virtual reality, a hologram of visualizers, colors, patterns, pictures, space, forests, oceans, mountains, people, cities or the like that are tied to each frequency. Colors may be important in enabling the viewers to associate specific sounds or frequencies with the visual displays, painting a visual image of the audio the user is performing. When visual displays are engaged, the user may control them, such as by tying it to the surround sound panning and grabbing, holding, or throwing visuals with the audio simultaneously in, over, through and around the entire audience.

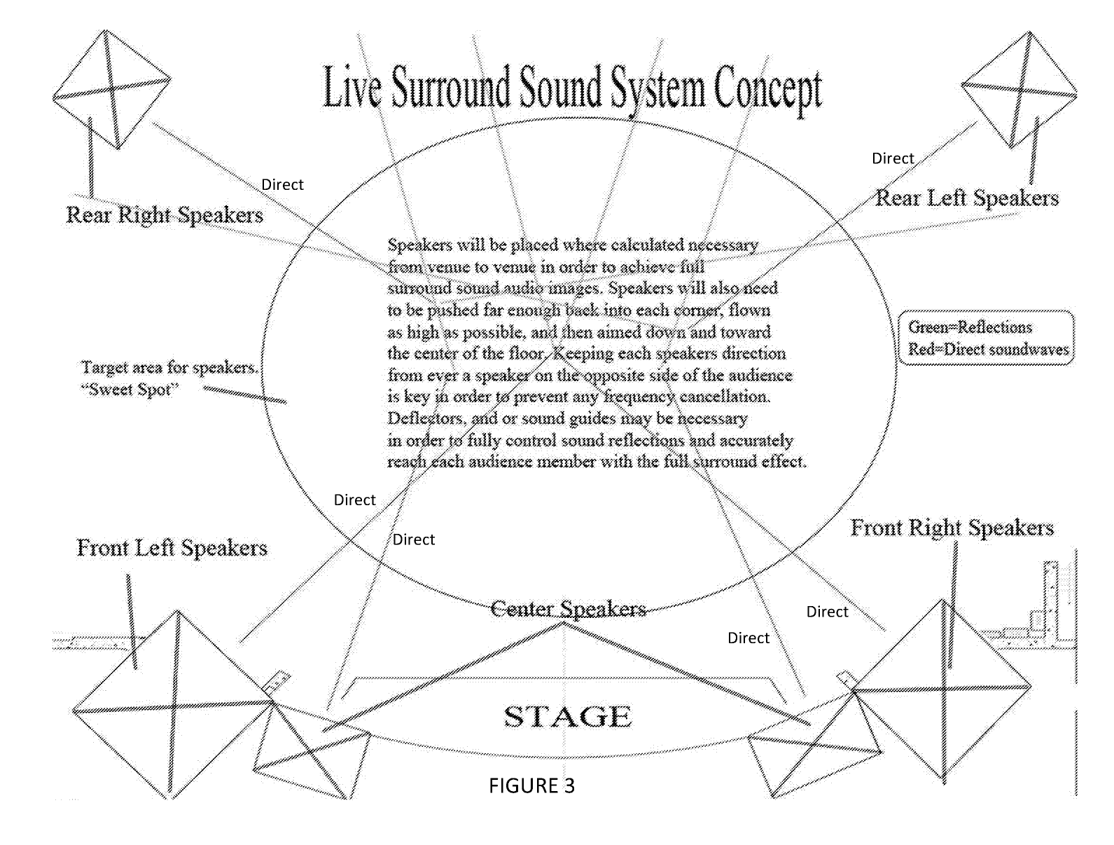

FIG. 3 depicts an example surround sound system that may be used in conjunction with or as part of a control system as described herein. FIG. 3, for example, shows a plurality of speakers arranged, such a pair of rear speakers (right and left), a pair of front speakers (right and left) and a pair of center speakers (right and left). The layout and selection of speakers and locations, however, is merely exemplary. FIG. 3 shows that the speakers may be arranged/placed in locations that are calculated/selected from venue to venue in order to achieve full surround sound audio images. The speakers may be located (e.g., moved back/front, left/right, up/down or otherwise) and aimed as desired. Selecting each speaker's direction may be adjusted, for example, to prevent or reduce frequency cancellation caused by other speakers in the system. Deflectors, sound guides, or other components may further be used to control or adjust sound reflections, such as to control sound reflections and accurately reach all or as many members of the audience with a desired or full surround sound effect. FIG. 3 further shows example direct sound waves for this particular example speaker configuration extending directly from each speaker shown in FIG. 3 (and labeled as “Direct” in FIG. 3). Reflected sound waves are further shown extending away from intersection of the direct sound waves that extend directly from the individual speakers.

### Implementation

In one implementation, a DJ may utilize all these features in a studio, recording or live performance. Performance features, such as the speakers, lights, and environment controls, may be set up around a crowd and calibrated to maximize the effects of such performance features. An X/Y pad is be set up on stage where a DJ would walk. Equipment such as a DJ table and instruments may be set up in the background, as well as an audio/light control surface for the engineer or designer to use and program the controls to if necessary. In some implementations, the system is designed to be used by oneself or in harmony with other users such as band members, sound engineers, dancers, lighting designers and video jockeys at the same time. Any one of these particular positions can control one or all elements of the system single handily or with multiple users.

The DJ would be wearing the performance gloves to direct the performance features during a performance. In a sample performance, a DJ may decide to start a performance behind a DJ table, and then walk out in front of the table to engage the audience. The DJ's movements and choreography would appeal to a wider audience and allow the crowd to associate motions with sound. At the same time, the DJ would slingshot the sounds around the audience and control how a crowd experiences the distance, direction, timing, and other auditory features. At the peak of a song, the sounds may swell to surround the audience, with the environment control controlling gentle bursts of warm air mixed with visual displays of bright reds and oranges (a warm pallet of colors) flying through to convince an audience's senses that they are being taken along an artist's journey. During the breaks of a song, the blasts of cold air is mixed with blues and purples (a cool pallet of colors) to deliver a complete calming sense attached to the mellow break in the music. Scents, known to trigger memories, may be used to manipulate the audience into feeling a certain way or remembering the performance. This multi-sensory performance would completely captivate an audience into a performer's full artistic expression. The possible technical applications to a sound engineer, lighting designer and video jockey would also ease and improve the control and accuracy for each of these vital positions in the performance.

Software designed and written specifically for this system giving programmable control over venue parameters throughout the entire system would be the main brain of the entire system, syncing/connecting to each individuals equipment to ensure all audio/physical/visual controls, timing, and programming are functioning properly and suggesting corrections when necessary. The software program could be used standalone or in combination with existing software to ensure the compatibility with each environment and user separately with ease.

Such program would be consist of but is not limited to: audio, visual and technical controls and effects within its standalone setting. Also a real time audio analyzer, that would display a picture of the audio readings, its frequencies, direction, reflection and cancellations using multiple directional microphones and time based reflection microphones that convert the analysis into a live video of what the audio is doing in each particular venue or studio, recording or live environment and where adjustments need to be made. The user would also have a function that enabled fine speaker adjustments once mounted to ensure and enhance the surround sound effect before and during the show. This allows the user to quickly set up and adjust the audio accordingly while moving about the venue with the control gloves on to deliver a nearly perfectly tuned mix in every studio, recording or live setting. It would have controls to assign one or multiple to users to programmed areas, controls, and parameters throughout the venue. Giving the other online users their own set of controls separate from the master control or enabling/assigning one master controller. This program would need to be able to control, or bridge into existing software and hardware used by DJs, musicians, engineers, and lighting designers.

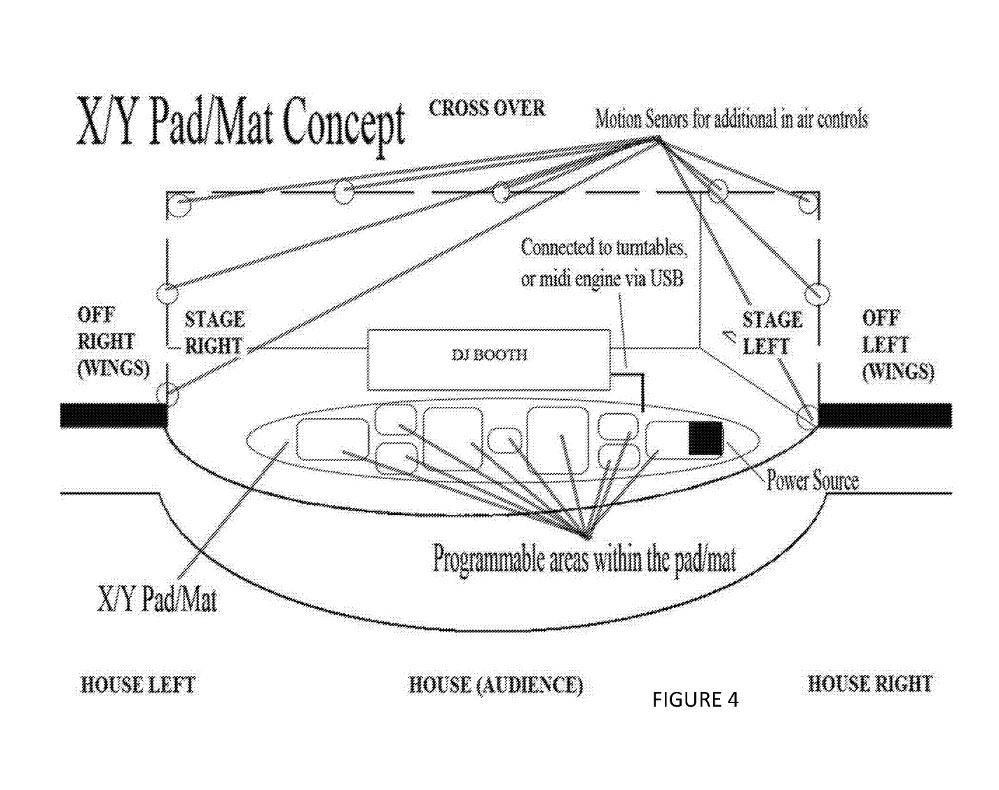

FIG. 4 shows an example implementation of a venue control system including various sensors for detecting activity by a user during a performance. In this implementation, for example, a DJ booth is located on a stage of the venue as shown in FIG. 4. A mat/pad is located on a floor of the stage disposed away from the DJ booth. The mat/pad, for example, may comprise an X/Y pad/mat that is adapted to detect a user's location within an X/Y coordinate system of the mat/pad as the user moves relative to the pad/mat. In this implementation, for example, different areas of the pad/mat may include a plurality of discrete programmable areas within the pad/mat dimensions. Thus, as a user moves across the pad, a controller is adapted to activate/engage different effects related to the performance such as described herein. In one implementation, for example, one or more input devices on a remote controller may be adapted to be assigned to control different parameters or effects related to the performance. Additionally or alternatively, the various programmable areas may further be used to directly control one or more parameters or effects related to the performance. A control system may be adapted to control volume, frequency, lighting or the like when a user stands or moves into a predetermined area/region of the X/Y pad/mat. For example, the control system may slowly or quickly increase the volume, frequency lighting intensity as long as the user is detected within a particular area/region.

FIG. 4 further shows a plurality of motion sensors that are adapted to provide inputs to the control system. The control system, for example, may be adapted to detect movement and/or location of a user on a stage. Thus, particular motions (e.g., a user running across the stage in a particular direction, motioning in a direction or the like) may be detected and the control system may control one or more parameter or effect of the performance based upon the determined motion and/or location of the user.

As shown in FIG. 4, the X/Y pad/mat may be coupled to the controller, performance equipment (e.g., instruments, turntables or other devices) via a wired or wireless connection.

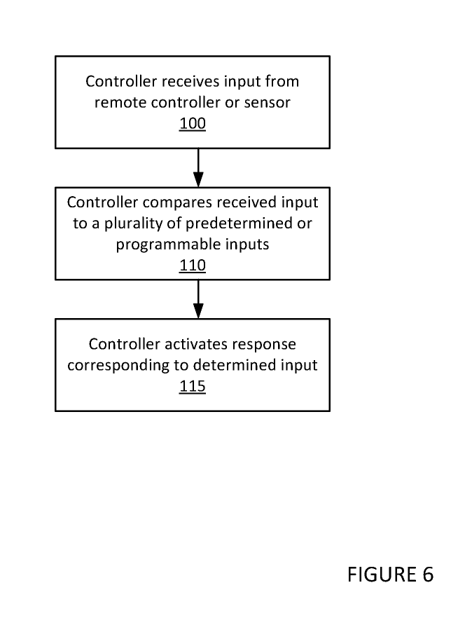

FIG. 6 shows an example implementation of operations that may be used within a control system such as described and shown herein. In FIG. 6, for example, a control system receives one or more inputs from a remote controller in operation 100. The remote controller may include a wearable remote controller (e.g., one or more gloves), a carryable remote controller (e.g., handheld), a remote controller positioned within a performance venue (e.g., on a stage, in an audience, within a studio or the like) or any other remote controller/sensor described or contemplated herein.

The controller compares the received input to a plurality of predetermined or programmable inputs corresponding to actions that may be detected within a performance in operation 110. The predetermined or programmable inputs, for example, may be stored in a table, file, database or any other data storage mechanism.

In response to the detection and/or identification of the received input, the controller activates one of more response in operation 115. The response, for example, may comprise activating or altering one or more parameter or effect for a performance. Thus, as described herein, the controller may be adapted to alter a volume, frequency, speed, output location (e.g., within a surround sound system), intensity, filter or other parameter or effect of one or more sound/song, lighting effect or other aspect of a performance.

In one implementation, for example, a surround sound control system including a remote control such as remote control glove(s) or other wearable device(s) is provided. In one example implementation, a DJ, artist, audio engineer, lighting designer or other user use the gloves or other controller in a studio, recording or live environment in one or more perspective “zones” of a venue. A performer zone, for example, could extend throughout a stage or other perimeter, while a sound engineer could have a zone corresponding to an audience are of the venue. Alternatively, inputs received from the controllers could be distinguished via one or more identifiers corresponding to different controllers (e.g., gloves or other remote controller devices). Thus, the DJ and/or sound engineer (or other user) could activate a component of the controller to generate a signal that is transmitted to a controller to perform an action for the performance. The DJ and/or sound engineer, for example, could press a button, activate a switch, slide a controller or take another action that triggers a programmed effect or parameter to turn on. Then once that effect or parameter is on, the user may then use a motion they have programmed to that parameter making the sound or song full effected or not at all based on where their hand(s) is. The movement can be programmed to the surround sound system and once the panning parameter has been engaged with the user pressing that specific button they could “throw” the sound via controlling the outputs of one or more speakers of a surround sound system around the entire venue/performance environment with the movement of their hand(s).

In another implementation, for example, a performer may activate a virtual instrument such as a virtual drum, keyboard, guitar or the like through the use of a remote controller, such as one or more gloves or other devices. In this implementation, for example, the user may flip a switch or other controller to activate another bank of buttons or other input devices on one or both of a pair of glove controllers. One button, for example, may be programmed or otherwise correspond to trigger drum sounds and be adapted to allow the performer to perform finger drumming on the spot. The performer could then step onto one or more stage floor triggers, trigger one or more motion and/or location sensors or the like that are adapted to detect the presence and/or absence of the performer within a zone (e.g., on or entering a stage). The controllers may be adapted to record, loop and create brand new drum sequences on the fly on a customizable, enlarged scale. The performer could thus be controlling a virtual drum with one hand and controlling a virtual synthesizer with the other hand. Thus, in this implementation, the controller is adapted to allow the performer to control both the notes being played with his/her fingers, and also control oscillators or envelopes with the motion of that specific hand.

In yet another implementation, atrium effects such as atrium X, X/Y and/or X/Y/Z effects are provided using a remote controller system. In this implementation, for example, a user could initiate and/or control an audio effect using the remote controller (e.g., one or more glove controllers). A roll effect, for example, may “grab” a small or large piece of a song/sound and loop it either slowly or rapidly depending on the user's preference. Once the user has “grabbed” or otherwise identified or selected the desired portion of the song/sound, the user may step into a zone based on a location of the glove(s) or other controller and depending on the coordinates or other location indicator of the user and or gloves the controller is adapted to allow the user to add, remove and/or edit effects and completely restructure any given sound/song in the air. In this implementation, the controller provides the ability to recreate anything the user selects instantly. Zones in a mapped area of coordinates, for example, may be pre-programmed and assigned to any other effects or triggers the user so chooses.

In another implementation, an audio engineer may use one or more remote controllers within a venue to control one or more audio effects or settings for a performance. In this implementation, for example, an audio engineer may move within an audience rather than staying in a fixed location behind a sound board and may adjust a mix of the venue or studio as he detects (e.g., hears or otherwise detects via one or more sensors on the remote controller) by engaging one or more input devices of the controller. For example, an audio engineer may select one or more track with a button on one hand of a pair of controller gloves and adjust a setting such as volume, frequency control or the like and changing the setting (e.g., adjust a volume or frequency control) of a specific track, sound, song or effect by raising or moving (e.g., raising/lowering) the controller such as on a glove disposed on the same or opposite hand.

In yet another implementation, a lighting designer or controller may use one or more remote controllers within the venue to control one or more lighting or other performance effects or settings for a performance. A lighting designer, for example, may engage one entire scene of lights by pressing one or more of a plurality of finger buttons or other input devices of the controller. Theuser may, for example, have pre-programmed a setting such as a motion one or both of the hands to control the motion and movements of each individual light or laser. In another implementation, for example, the controller may be adapted to control a function and one or more of the lights will follow the motion of his hand at the same time. Then, the user may continue control to another/next set of light (e.g., colored lights) by selecting (e.g., clicking another button) an input device one one or more of the user's hands. A lighting designer or other user could even shut all lights off, turn on a spotlight with a pre-programmed input device (e.g., a button) on the remote controller (e.g., glove) and then use a motion of the user's hand to point at a performer and follow them with the spotlight without needing to have someone physically moving the following spotlight.

In another implementation, a performer (e.g., a DJ) may control one or more effects of a performance (e.g., a sound effect) using a remote controller system. In one implementation, for example, the performer may be located at a particular region (e.g., the front) of a stage or other performance location and engage a loop. The performer may control the playback of the loop via one or more control features of the remote control. The performer, for example, may engage different input devices of the controller (e.g., one or more buttons) to control playback speed of the looped audio portion. The performer, for example, may select one or more pre-programmed speeds or other effects (e.g., 0.5 times, 1.0 times, 1.5 times, 2.0 times, etc.) via selection of one or more input devices, control the speed or other effects via one or more continuous (e.g., a slide) input device of the controller over a continuous range of outputs (e.g., speed, volume, frequency response, etc.). In one implementation, for example, as the performer controls a speed of a loop to play back faster and faster, the controller is adapted to allow the performer to engage a filter by clicking or otherwise selecting an input device (e.g., button) of the controller (e.g., glove controller) and then motion is engaged on that hand only for an audio filter. As the performer sweeps controller, the control system may change one or more effects related to the sound/song, such as playing the sound/song of the selected loop faster and faster. The performer may also can engage a surround sound system and when the increased speed is at a peak the performer can disengage the filter motion control. When the sound is about to drop the performer can “throw” the sound such as by moving the controller (e.g., in a throwing motion) all the way out to rear speakers to give the listeners the idea that the sound was thrown behind them and nearly out of the venue. Then the performer may disengage all effects. As the sound fades, all parameters and effects may be returned (at once or gradually) back to a nominal level and panning may be returned to the front of the performance area. Further, the performer may use another motion (e.g., a punch) effect to trigger another effect. For example, the performer may throw a punch and by clenching his/her fist to trigger a drop that launches a chorus and highest energy peak of a sound/song.

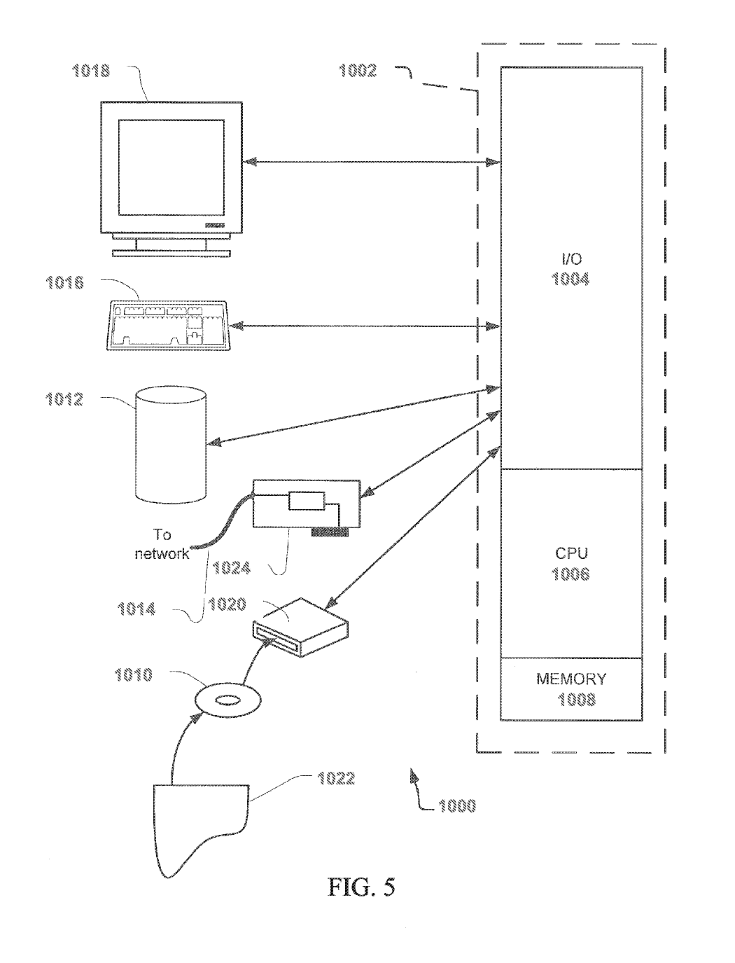

FIG. 5 is a schematic diagram of an example computing device 1000 upon which the controller of the venue control system may be implemented. As discussed herein, implementations may include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

FIG. 5 illustrates an exemplary system useful in implementations of the described technology. A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 5 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 5 into a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. Computer program products containing mechanisms to effectuate the systems and methods in accordance with the described technology may reside in the memory section 1008, on a disk storage unit 1012, or on the DVD/CD-ROM medium 1010 of such a system 1000. Alternatively, a disk drive unit 1020 may be replaced or supplemented by a floppy drive unit, a tape drive unit, or other storage medium drive unit. The network adapter 1024 is capable of connecting the computer system to a network via the network link 1014, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

In accordance with an implementation, software instructions and data directed toward operating the subsystems may reside on the disk storage unit 1012, disk drive unit 1020 or other storage medium units coupled to the computer system. The software instructions may also be executed by CPU 1006.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of a particular computer system. Accordingly, the logical operations making up the embodiments and/or implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

The detailed description in connection with the appended drawings is intended as a description of example implementations and is not intended to represent the only forms in which the present invention may be constructed and/or utilized. The description sets forth example functions and sequences of steps for constructing and operating systems and methods in connection with the illustrated implementations. However, it is to be understood that the same or equivalent functions and sequences may be accomplished by different implementations that are also intended to be encompassed within the spirit and scope of the inventions (exclusive surround sound system technology, sound engineer controls, lighting designer controls, visual jockey controls, disk jockey controls, temperature controls) full studio, recording or live venue control system.

Although implementations of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A control system for controlling one or more parameter or effect of a performance, the control system comprising:
a remote control device comprising at least one input device adapted to receive an input from a performer during a performance;
a controller coupled to the remote control device and adapted to receive an input from the remote control device and control the one or more parameter or effect of the performance, wherein the remote control device is adapted to move with a user within a venue of the performance.

2. The control system of claim 1 wherein the remote control device comprises a wearable remote control device.

3. The control system of claim 2 wherein the wearable remote control device comprises at least one glove.

4. The control system of claim 1 wherein the remote control device comprises one or more output device for displaying information to a wearer.

5. The control system of claim 4 wherein the information comprises at least one of a status of the input device, a selected mode of the input device, a programmed mode of the input device.

6. The control system of claim 1 wherein the parameter or effect comprises at least one of a volume, frequency, intensity, location, distribution and motion of the performance.

7. The control system of claim 1 wherein the parameter or effect comprises at least one of a volume, frequency, intensity, location, distribution and motion of a sound of the performance.

8. The control system of claim 1 wherein the parameter or effect comprises at least one of a volume, frequency, intensity, location, distribution and motion of a light effect of the performance.

9. The control system of claim 1 wherein the parameter or effect comprises at least one of a volume, frequency, intensity, location, distribution and motion of a temperature related to the performance.

10. The control system of claim 1 wherein the parameter or effect comprises at least one of a volume, frequency, intensity, location, distribution and motion of an airflow within the performance and the control system controls at least one or more fan within the venue to control the parameter or effect.

11. The control system of claim 1 wherein the system comprises a sensor pad adapted to receive an input related to a location of a performer within the performance and the controller is adapted to receive an input from the sensor pad and control a second parameter or effect of the performance.

12. The control system of claim 1 wherein the system comprises a motion sensor adapted to receive an input related to a motion of a performer within the performance and the controller is adapted to receive an input from the motion sensor and control a second parameter or effect of the performance.
